(19) United States
(12) Patent Application Publication
(10) Pub. No.: US 2018/0083444 A1
(43) Pub. Date: Mar. 22, 2018

(54) ZERO DC POWER DELIVERY

(71) Applicant: Apple Inc., Cupertino, CA (US)

(72) Inventors: Narendra S. Mehta, San Mateo, CA (US); Michael B. Nussbaum, Santa Cruz, CA (US)

(73) Assignee: Apple Inc., Cupertino, CA (US)

(21) Appl. No.: 15/463,558

(22) Filed: Mar. 20, 2017

Related U.S. Application Data
(60) Provisional application No. 62/397,935, filed on Sep. 22, 2016.

(51) Int. Cl. H02J 1/00

(52) U.S. Cl. CPC H02J 1/00

(57) ABSTRACT

Methods, structures, and apparatus that are able to transfer power through a device power contact while minimizing its corrosion. During a first period, a power supply may be connected to the device power contact. During a second, subsequent period the power supply may be disconnected from the device power contact and a quasi-resonant circuit connected to the device power contact may cause a voltage on the device power contact to ring. At the end of the second period, the voltage on the device power contact may be approximately equal to a voltage of the power supply. The power supply voltage may have a first polarity and the voltage on the device power contact may have a second polarity for a portion of the second period, the second polarity opposite the first polarity.

### CROSS-REFERENCES TO RELATED APPLICATIONS

This application claims the benefit of U.S. patent application No. 62/397,935, filed Sep. 22, 2016, which is incorporated by reference.

### BACKGROUND

The amount of data transferred between electronic devices has grown tremendously the last several years. Large amounts of audio, streaming video, text, and other types of data content are now regularly transferred among desktop and portable computers, media devices, handheld media devices, displays, storage devices, and other types of electronic devices.

Power and data may be provided from one electronic device to another over cables that may include one or more wire conductors, fiber optic cables, or other conductors. Connector inserts may be located at each end of these cables and may be inserted into connector receptacles in the communicating or power transferring electronic devices. Contacts in or on a connector insert may form electrical connections with corresponding contacts in a connector receptacle. Other devices may have contacts at a surface of a device. Pathways for power and data may be formed when devices are attached together or positioned next to each other and corresponding contacts are electrically connected to each other.

These various contacts in connector inserts, in connector receptacles, or on a surface of a device, may be exposed to the local environment. These contacts may encounter liquid, moisture, or other damaging contaminants. For example, liquids may be spilled on these contacts or a device may be set down such that its contacts land in a puddle of liquid. Users may swim or exercise while wearing or holding an electric device. These activities may put contacts for the electronic devices in a position to encounter various contaminants.

These liquids or other contaminants may corrode and damage the contacts. This corrosion may be greatly exacerbated by the presence of an electric field, such as when a voltage is applied to a contact. The result is that power contacts may be particularly susceptible to corrosion.

Thus, what is needed are methods, structures, and apparatus that are able to deliver power through a device contact while minimizing its corrosion.

### SUMMARY

Accordingly, embodiments of the present invention may provide methods, structures, and apparatus that are able to deliver power through a device contact while minimizing its corrosion. An illustrative embodiment of the present invention may provide methods, structures, and apparatus that are able to deliver power through a power contact while minimizing corrosion by delivering power using an alternating voltage that has an average voltage of (or near) zero volts.

Contacts on electronic devices may be exposed to corrosive materials and fluids. These contaminants may include ions that may migrate into a contact in the presence of an electric field. In the absence of an electric field, these ions do not tend to migrate into a contact and corrosion is greatly reduced. By applying an alternating electric field, the net migration of ions into and out of a contact may be reduced. By applying an alternating electric field with a voltage that has an average value of, or near, zero volts, the migration of ions into a contact may be at least approximately equal to the migration of ions out of the contact. This symmetrical migration may reduce corrosion of the contact.

An illustrative embodiment of the present invention may deliver power using a voltage waveform that is generated using a two-step process. In a first step, a power supply voltage having a first polarity may be connected to a device power contact and power may be transferred. After the first step, a second step may follow, during which the voltage on the device power contact may be driven such that the voltage on the device power contact has an average value of at least approximately zero volts for the combination of the first step and the second step. During this second step, the voltage on the device power contact may ring such that it has a second polarity for at least some of the second step, where the second polarity is opposite the first polarity.

An illustrative embodiment of the present invention may provide a host device having a device power contact and an accessory having an accessory power contact. The device power contact may electrically connect to the accessory power contact, either directly or through a cable, during a transfer of power from the host device to the accessory. During a first time period (or simply period), the host device may provide a power supply voltage to the device power pin via a closed switch. A first quasi-resonant circuit in the accessory may receive the power supply voltage and may provide a sinusoidal current pulse into a filter. When the current pulse returns to zero, the first period may end and a second period may begin. When the second period begins, the switch may be opened and the power supply may be disconnected from the device power contact. A second quasi-resonant circuit may generate a sinusoidal voltage pulse on the device power contact during the second period such that an average value of the voltage on the device power contact for the combined first and second periods is at least approximately zero volts. At the end of the second period, the switch may again close connecting the power supply voltage to the device power contact. The process may repeat thereby generating an alternating voltage having an average value at or near zero volts at the device power contact.

In these and other embodiments of the present invention, the timing of these events, that is, the length of the first period and the second period, may be set or determined in various ways. For example, the lengths of the first and second periods may be set in an open-loop manner. Specifically, a control voltage may be used to open and close the switch in an open-loop configuration. In these and other embodiments of the present invention, feedback may be employed to control the length of the first period, the second period, or both, in a closed loop configuration.

For example, in these and other embodiments of the present invention, the switch may close and the second period may end when the voltage on the device power contact is again equal to the power supply voltage. This may be determined using a comparator that compares the power supply voltage to the voltage on the device power contact. Since the voltage at the device power contact is at least approximately equal to the power supply voltage when the switch is closed, a discontinuity or step that may otherwise result when the power supply is reconnected to the device power contact may be reduced or eliminated.

In these and other embodiments of the present invention, instead of comparing a voltage on the device power contact to a power supply voltage, an area detector may be employed to determine when the second period should end. Again, an average value of zero volts at the device power contact may result in minimized corrosion. Accordingly, an area detector may integrate the voltage at the device power contact. When an average value of the voltage at the device power contact at least approximately zero volts, the switch may close. Stated another way, when the area under the voltage waveform at the device power contact is zero, the switch may close thereby beginning another cycle of an alternating voltage waveform at the device power contact.

Again, the length of the first period may be controlled in a close-loop manner. For example, a current into the accessory may be monitored using a current sense circuit. Specifically, when the switch closes, the first quasi-resonant circuit may provide a pulse of current into a filter. When this current pulse returns to zero, the current sense circuit may open the switch, thereby ending the first period and starting the second period.

In these and other embodiments of the present invention, the power supply voltage may be provided by a battery, such as rechargeable battery. The battery may be inserted or attached to the host device. The power supply may be a power supply that is provided to the host device from an external source, or other power supply. The switch may be a transistor, such as an N-channel metal-oxide-semiconductor field-effect transistor (MOSFET), P channel MOSFET, or bipolar or other type of transistor, or it may be a micro-electro mechanical (MEM) switch, relay, or other type of switch. The second quasi-resonant or tank circuit may include an inductor and a capacitor, though it may include other devices, such as active devices, as well. The rectifier may include a diode. An inductor may be placed in series with the diode to increase the conductive angle of the diode and provide some filtering to the current waveform. The inductor may be an inductance of a cable, though an additional series inductor may be used as well. The rectifier may provide current to a filter that may be a capacitor. The series inductor and this capacitor may form the first quasi-resonant circuit. An end of a cycle (or end of the second period) may be determined using a comparator having a first input coupled to the device power contact, a second input coupled to the battery, and an output coupled to a control voltage circuit, where the control voltage circuit opens and closes the switch. In these and other embodiments of the present invention, the comparator may be a comparator, an amplifier, or other circuit. Alternatively, an end of a cycle may be determined using an area detector, such as an amplifier having a resistor in series with an input and a capacitor coupled in a feedback path from the input to an output of the amplifier. The area detector may have an input coupled to the device power contact and an output coupled to the control voltage circuit. An end of the first duration may be determined using a current sense circuit that may be a series resistance having at least one terminal connected to the control voltage circuit.

In these and other embodiments of the present invention, an alternating voltage having a zero average value may be provided on a device power contact of a host device. This may reduce corrosion on the device power contact while allowing the device power contact to be used in delivering power to an accessory. Corrosion may similarly be reduced on contacts of connector inserts at each end of a cable (if used), as well as on an accessory power contact of the accessory.

In these and other embodiments of the present invention, a battery may provide a positive voltage and when the second quasi-resonant or tank circuit rings, it may ring below ground. In these and other embodiments of the present invention, a battery may provide a negative voltage and when the quasi-resonant or tank circuit rings, it may ring above ground.

In these and other embodiments of the present invention, a host device may provide power to an accessory and the host device may include the battery, the switch, and the second quasi-resonant circuit, while the accessory may include the rectifier and the first quasi-resonant circuit. In these and other embodiments of the present invention, an accessory may provide power to a host device and the accessory may include the battery, the switch, and the second quasi-resonant circuit, while the host device may include the rectifier and the first quasi-resonant circuit. In these and other embodiments of the present invention, each device may be capable of providing power to the other and may each include these or other circuits.

Embodiments of the present invention may provide power transfer circuits and apparatus that may be located in various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, adapters, remote control devices, chargers, and other devices.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates an electronic system that may be improved by the incorporation of an embodiment of the present invention;

FIG. 2 illustrates a block diagram of a power transfer system according to an embodiment of the present invention;

FIG. 3 is a timing diagram for the power transfer system of FIG. 2;

FIG. 4 illustrates a simplified schematic of the power transfer system of FIG. 2;

FIG. 5 is a flowchart of the operation of the power transfer system of FIG. 2;

FIG. 6 illustrates a block diagram of a power transfer system that includes a comparator according to an embodiment of the present invention;

FIG. 7 illustrates a simplified schematic of the power transfer system of FIG. 6;

FIG. 8 is a flowchart of the operation of the power transfer system of FIG. 6;

FIG. 9 illustrates a block diagram of a power transfer system that includes an area detector according to an embodiment of the present invention;

FIG. 10 illustrates an integration of a voltage at a device power contact of the power transfer system of FIG. 9;

FIG. 11 illustrates a simplified schematic of the power transfer system of FIG. 9;

FIG. 12 is a flowchart of the operation of the power transfer system of FIG. 9;

FIG. 13 illustrates a block diagram of a power transfer system that includes a current sense circuit according to an embodiment of the present invention;

FIG. 14 illustrates a simplified schematic of the power transfer system of FIG. 13; and

FIG. 15 is a timing diagram for a voltage delivery system according to an embodiment of the present invention.

### DESCRIPTION OF ILLUSTRATIVE EMBODIMENTS

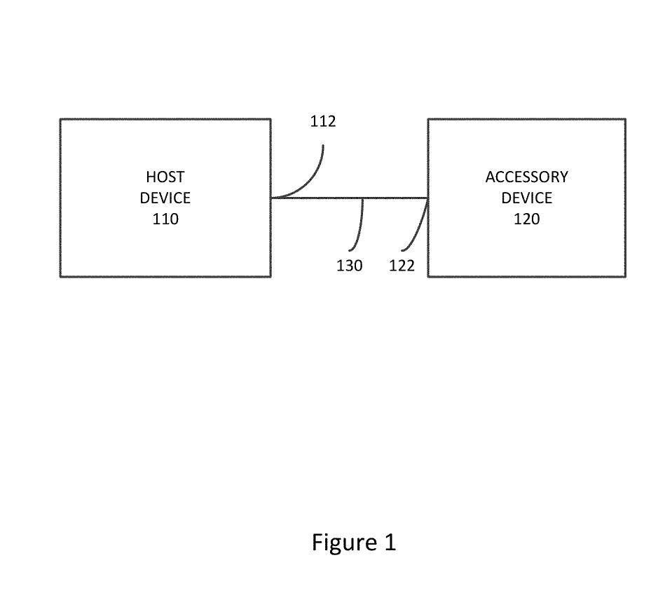

FIG. 1 illustrates an electronic system that may be improved by the incorporation of an embodiment of the present invention. This figure, as with the other included figures, is shown for illustrative purposes and does not limit either the possible embodiments of the present invention or the claims.

In this example, host device 110 may be connected to accessory device 120 in order to share data, power, or both. Specifically, contacts 112 on host device 110 may be electrically connected to contacts 122 on accessory device 120. Contacts 112 on host device 110 may be electrically connected to contacts 122 on accessory device 120 via cable 130. In other embodiments of the present invention, contacts 112 on host device 110 may be directly and electrically connected to contacts 122 on accessory device 120. In various embodiments of the present invention, contacts 112 and 122 may be power contacts or other types of contacts. Examples of embodiments of the present invention where contacts 112 and 122 are power contacts are shown in the following figures. In each of these figures corresponding ground contacts may be included but are omitted here for clarity. In these examples these contacts may be referred to as device power contact 112 and accessory power contact 122.

Embodiments of the present invention may transfer power from host device 110 to accessory 120 using a voltage at device power contact 112 that may be an alternating voltage having an average value near zero volts. This may provide a reduced or low level of ion migration into the contact, thereby reducing corrosion of the device power contact when the device power contact is exposed to contaminants. An example is shown in the following figure.

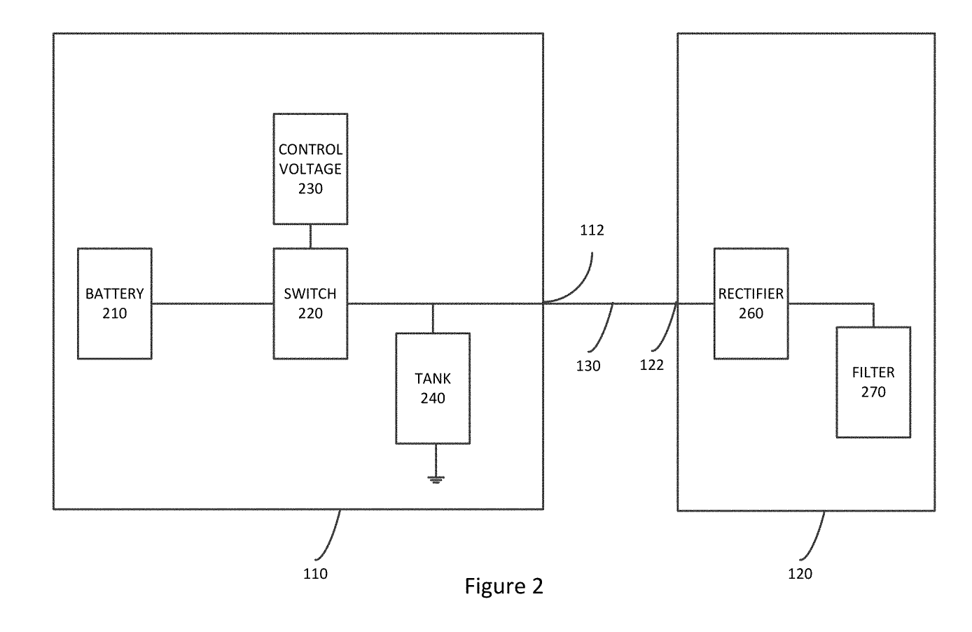

FIG. 2 illustrates a block diagram of a power transfer system according to an embodiment of the present invention. This figure illustrates host device 110 having device power contact 112 and accessory 120 having accessory power contact 122. Device power contact 112 may electrically and physically connect to accessory power contact 122. In these and other embodiments of the present invention, device power contact 112 may instead connect to accessory power contact 122 via cable 130.

Host device 110 may include a power supply, shown here as battery 210. Battery 210 may instead be a power supply provided externally, or it may be another type of power supply. Switch 220 may connect an output voltage of battery 210 to device power contact 112 during a first period. Switch 220 may be a transistor, a MEM switch, relay, multiplexer, or other type of switch. Switch 220 may be under control of control voltage circuit 230, which may close switch 220 during the first period.

During the first period, the voltage at device power contact 112 may be received by accessory power contact 122 and provided to rectifier 260. Rectifier 260 may provide current into filter 270. Rectifier 260 may include an inductor in series with a diode. This rectifier may be a half-wave rectifier, though rectifier 260 may be a full-wave rectifier in other embodiments of the present invention. Filter 270 may be a capacitor or other charge storage component. More specifically, at the start of the first period when switch 220 closes, a first quasi-resonant circuit may provide a current pulse through rectifier 260. The first quasi-resonant circuit may include the series inductor of rectifier 260 and the capacitor of filter 270. When the current pulse returns to zero, the first period may end.

After the first period ends, control voltage circuit 230 may open switch 220. Control voltage circuit 230 in this example may be an open-loop circuit that may be driven by a timer or other circuit. Once the voltage at device power contact 112 is not determined by battery 210, a second quasi-resonant circuit may cause the voltage at device power contact to ring. When battery 210 provides a positive voltage, the ringing may drive the voltage at device power contact 112 below ground and negative. When battery 210 provides a negative voltage, the ringing may drive the voltage at device power contact 112 above ground and positive. The second quasi-resonant circuit may be tank circuit 240. Tank circuit 240 may include a parallel combination of an inductor and capacitor, though in other embodiments the present invention, it may include other passive or active devices. At the end of the second period, the voltage at device power contact 112 may be at least approximately equal to the voltage provided by battery 210 and control voltage circuit 230 may again switch 220 closed, thereby connecting battery 210 to device power contact 112. At this time, the above sequence may start again. An example of the resulting waveforms is shown in the following figure.

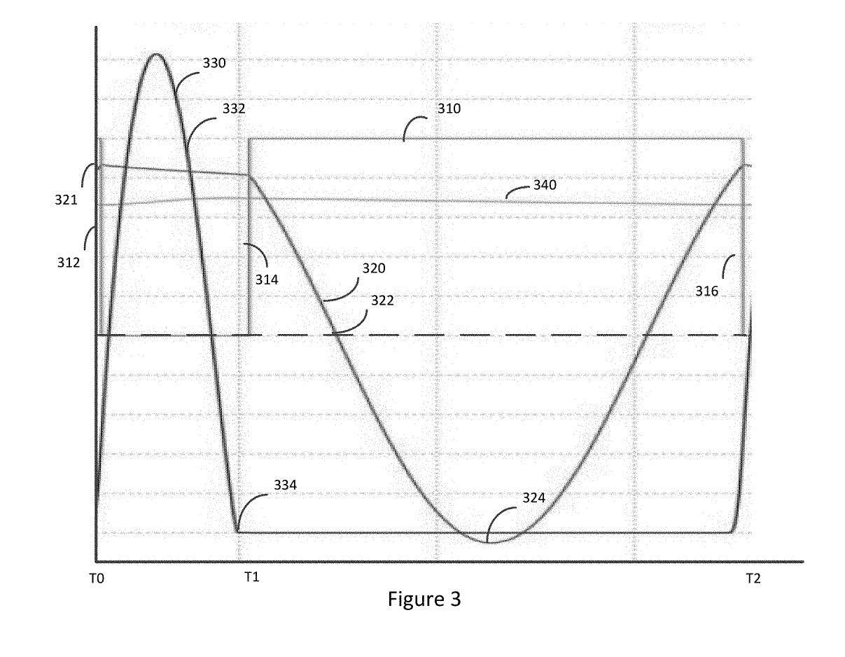

FIG. 3 is a timing diagram for the power transfer system of FIG. 2. In this example, waveform 310 may be an output of control voltage circuit 230 which may drive switch 220, where switch 220 is a P-channel MOSFET. Accordingly, at time T0, voltage 310 may go low at edge 312, thereby connecting battery 210 to device power contact 112. The voltage at device power contact 112 may be shown here as waveform 320. Waveform 320 may have an initial value 321 at time T0, which may be approximately equal to the voltage provided by battery 210. This voltage may droop due to the ON resistance (RDSON) of the P-channel MOSFET used as switch 220. The voltage at device power contact 112 may be received by accessory power contact 122. This received voltage may generate a current in the first quasi-resonant circuit. This current is shown here as current waveform 330. This current may flow be provided by rectifier 260 to filter 270. The filter voltage is shown as waveform 340. The current waveform 330 may include current pulse 332. The current pulse 332 may return to approximately zero at time 334. Following this, the first period may end at time T1. At time T1, the output of control voltage circuit 230 may go high, shown here as edge 314, thereby opening switch 220 and disconnecting battery 210 from device power contact 112. At time T1, the second period may commence.

Once battery 210 is disconnected from device power contact 112, the second quasi-resonant circuit, tank circuit 240, may cause the voltage at device power contact to ring with a sinusoidal waveform. Tank circuit 240 may cause the voltage at device power contact 112 to ring below ground at time 322, reaching a negative peak 324. This voltage may continue to ring until it at least approximately reaches the voltage provided by battery 210 at time T2. At time T2, the output 310 of control voltage circuit 230 may go low at edge 316, thereby ending the second period.

Various circuit components and devices may be used to implement the block diagram of FIG. 2. An example is shown in the following figure.

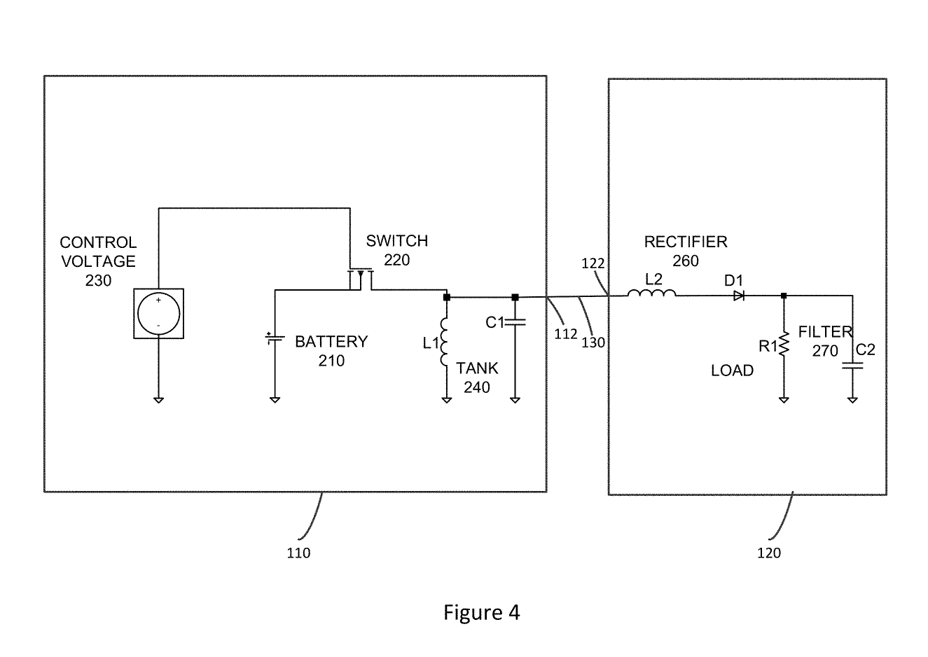

FIG. 4 illustrates a simplified schematic of the power transfer system of FIG. 2. Battery 210 is shown as a battery, though in these and other embodiments of the present invention, battery 210 may be replaced by another type of power supply, for example a power supply provided from an external source. Switch 220 is shown here as a P-channel MOSFET, though in other embodiments of the present invention, switch 220 may be an N-channel MOSFET, a bipolar or other type of transistor, a MEM switch, relay, multiplexer, or other type of circuit. Tank circuit 240 may be a parallel combination of an inductor and capacitor, shown here as inductor L1 and capacitor C1. Inductor L1 and capacitor C1 may form the second quasi-resonant circuit. In other embodiments of the present invention, one or more active devices may be included, for example to replace inductor L1. Rectifier 260 may include diode D1. In this example, diode D1 may form a half-wave rectifier, though in other embodiments of the present invention, a full wave rectifier or other circuit may be employed. Rectifier 260 may further include inductor L2. Inductor L2 may be an inductance of cable 130, it may be a discrete inductor added to, or in series with, accessory 120, or it may be a combination of both. In other embodiments of the present invention, inductor L2 may be replaced by an active circuit. Filter 270 is shown as capacitor C2, though filter 270 may be another type of charge storage circuit. Inductor L2 and capacitor C2 may form the first quasi-resonant circuit. Resistor R1 may be included to illustrate a load which may be the circuitry (not shown) of accessory 120.

In this example, the duration of the current pulse 332 shown in FIG. 3 may be determined by the load current and the values of the series inductor L2 and filter capacitor C2. The duration of the first period, shown in FIG. 3 as T1, may be set to be longer than the duration of the current pulse 332, shown in FIG. 3 as time 334. Any additional time that the switch is closed may result in the voltage at device power contact 112, shown as waveform 320 in FIG. 3, being high longer than necessary. This may result in the negative going pulse, shown in FIG. 3 as 324, at device power contact 112 to ring to a larger negative voltage that it otherwise would. The duration of the second period, shown in FIG. 3 as being between T1 and T2, may be set by the resonant frequency of the second quasi-resonant circuit formed by inductor L1 and capacitor C1. That is, the second period may be at least approximately equal to a half period of the resonant frequency of inductor L1 and capacitor C1. The voltage of the negative going pulse, show in FIG. 3 as 324, at device power contact 112 may be determined by the ratio of the duration of the second period to the duration of the first period.

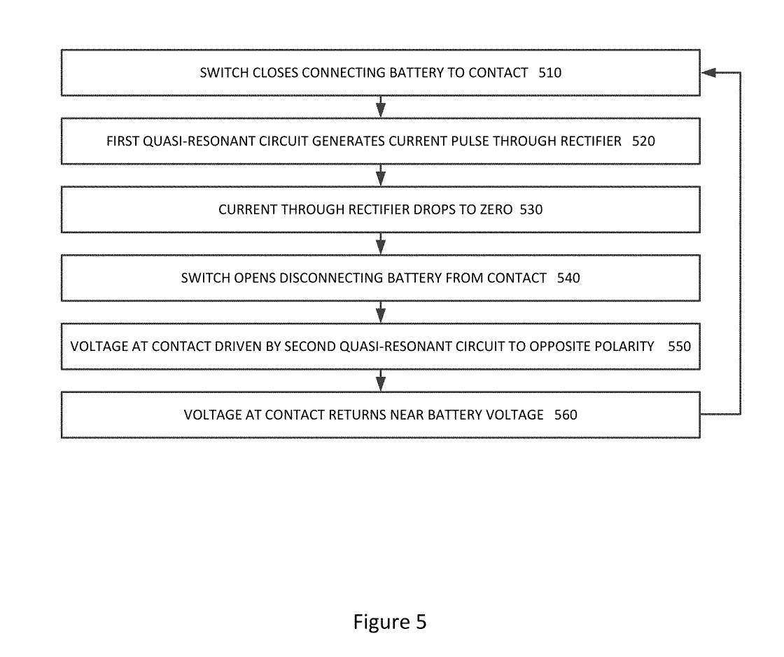

FIG. 5 is a flowchart of the operation of the power transfer system of FIG. 2. In act 510, a switch may close connecting a battery to a contact. In act 520, a first quasi-resonant circuit may provide current through a rectifier. In act 530, current through the rectifier may drop to at least approximately zero. The switch may then open, thereby disconnecting the battery from the contact in act 540. A second quasi-resonant circuit may drive the voltage at the contact to an opposite polarity in act 550. In act 560, the voltage on the contact may be near the battery voltage. The switch may again close in act 510, thereby starting a new cycle.

Again, it may be desirable to reduce a net migration of ions into a contact to a minimal or near zero level. Thus, it may be desirable for an average value of the voltage at device power contact 112 to be near zero volts. An embodiment of the present invention may reduce the average value by using feedback to provide a closed loop mechanism for determining when the second period should end. An example is shown in the following figure.

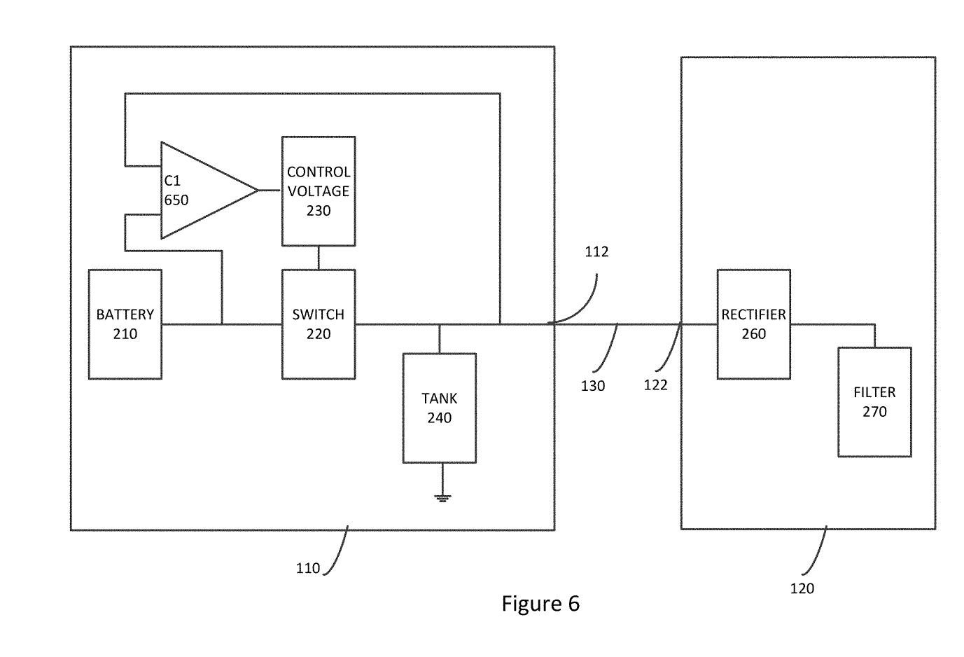

FIG. 6 illustrates a block diagram of a power transfer system according to an embodiment of the present invention. In this example, host device 110 may compare the voltage of battery 210 to the voltage on device power contact 112. Near the end of the second period, when the voltage of battery 210 and the voltage on device power contact 112 are at least approximately equal, comparator C1 650 in host device 110 may provide an output to control voltage circuit 230. More specifically, when the voltage at device power contact 112 rises above the voltage of battery 210, comparator C1 650 in host device 110 may provide an output to control voltage circuit 230. Control voltage circuit 230 may then drive switch 220 on, thereby connecting battery 210 to device power contact 112. Since the voltage at device power contact 112 is at least approximately equal to the voltage of battery 210 when switch 220 is closed, a discontinuity or step that may otherwise result when battery 210 is reconnected to device power contact 112 may be reduced or eliminated.

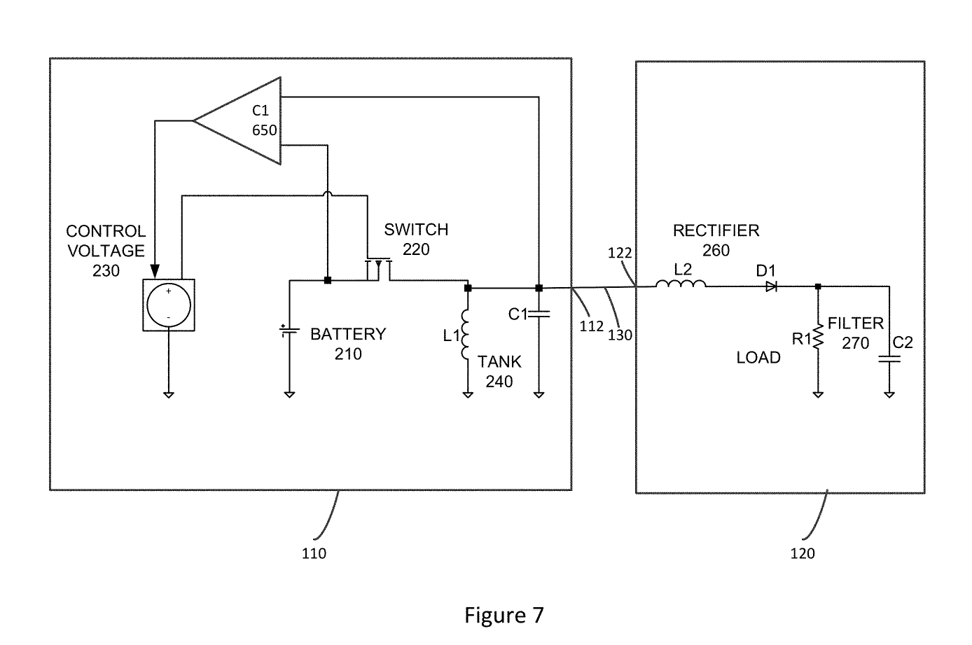

FIG. 7 illustrates a simplified schematic of the power transfer system of FIG. 6. Comparator 650 may have inputs coupled to battery 210 and device power contact 112. When the voltage at device power contact 112 rises above the voltage of battery 210, comparator 650 may provide a voltage to control voltage circuit 230. Control voltage circuit 230 may then close switch 220.

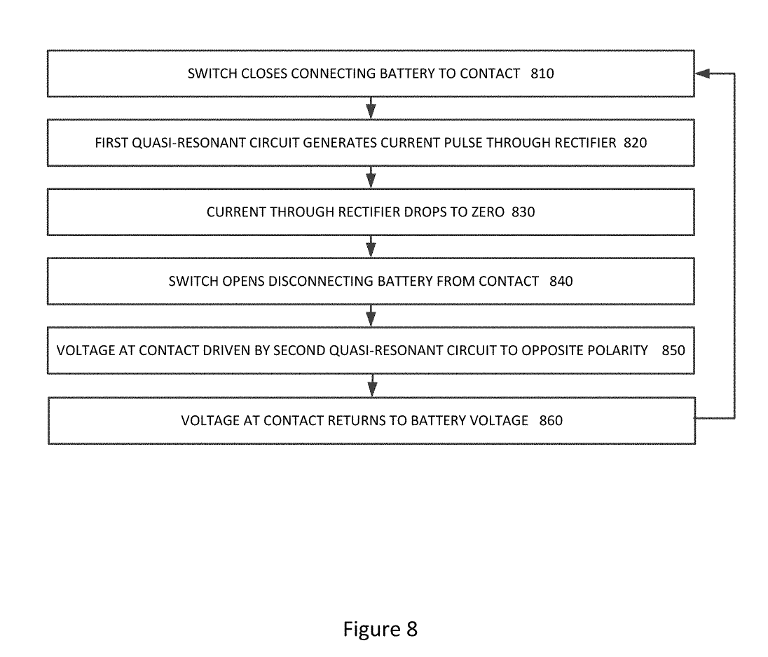

FIG. 8 is a flowchart of the operation of the power transfer system of FIG. 6. In act 810, a switch may close connecting a battery to a contact. In act 820, a first quasi-resonant circuit may provide current though a rectifier. In act 830, current through the rectifier may drop to at least approximately zero. The switch may then open, thereby disconnecting the battery from the contact in act 840. A second quasi-resonant circuit may drive the voltage at the contact to an opposite polarity in act 850. In act 860, a comparator may determine that the voltage on the contact has reached the battery voltage. The switch may again close in act 810, thereby starting a new cycle.

Again, it may be desirable to reduce a net migration of ions into a contact to a minimal or near zero level. Thus, it may be desirable for an average value of the voltage at device power contact 112 to be near zero volts. Accordingly, the present invention may include an area integrator, where the integrator determines an average value of a voltage at device power contact 112. An example of such a system is shown in the following figure.

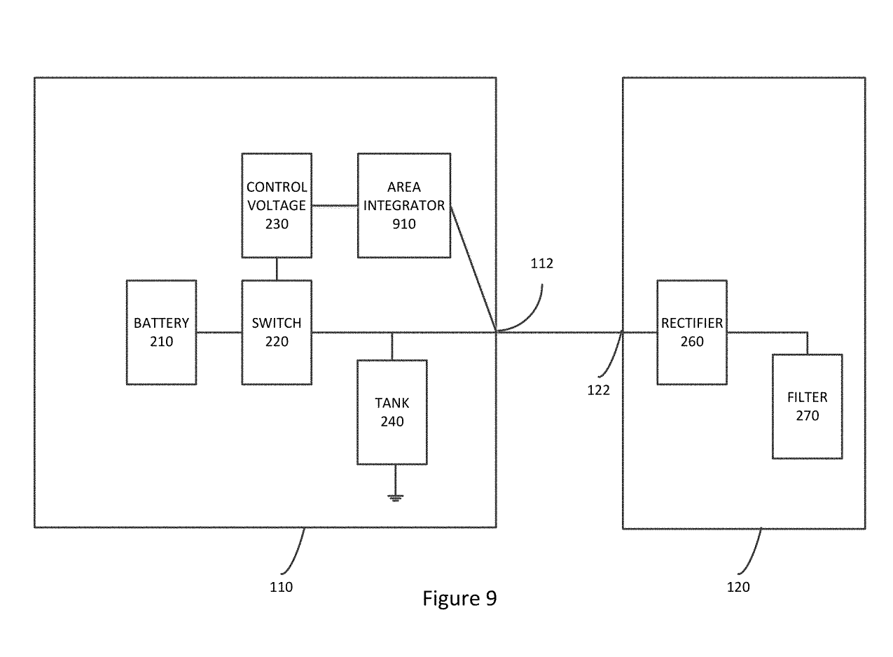

FIG. 9 illustrates a block diagram of a power transfer system that includes an area detector according to an embodiment of the present invention. As before, an alternating voltage having an average value of zero volts may be generated at device power contact 112. This voltage may be generated by providing a voltage from battery 210 on device power contact 112 via switch 220, then releasing the voltage and allowing the second quasi-resonant circuit, tank 240, to generate an opposite-polarity sinusoidal voltage pulse on device power contact 112. When the average value of the voltage on device power contact 112 reaches zero, area integrator 910 may provide an output to control voltage circuit 230. Control voltage circuit 230 may again close switch 220, beginning the cycle again. An example showing the integration of the voltage at device power contact 112 follows.

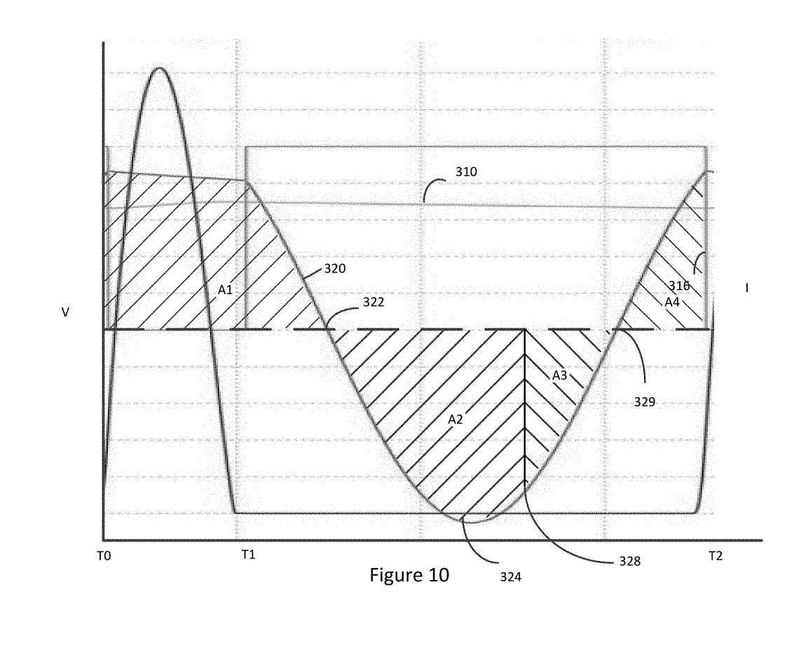

FIG. 10 illustrates an integration of a voltage at a device power contact of the power transfer system of FIG. 9. Again, host device 110 in FIG. 9 may include an area integrator 910. Area integrator 910 may average the voltage at device power contact 112. Put another way, area integrator 910 may integrate an area under the voltage waveform provided at device power contact 112, shown here as waveform 320. Again, during the first period from T0 to T1, switch 220 may connect battery 210 to device power contact 112. At time T1, switch 220 may open, and tank circuit 240, the second quasi-resonant circuit, may pull the voltage waveform 320 low. Waveform 320 may reach ground at time 322. An area under the voltage waveform curve during this time is represented here as area A1. Waveform 320 may continue to go negative and may reach a negative peak at 324. The waveform may then rise. The area under the curve 320 from time 322 to time 328 may be represented by area A2. Area A1 may be at least approximately equal to area A2. Accordingly, area integrator 910 may reach a level near zero. Control voltage circuit 230 may ignore this and area integrator 910 may continue to integrate the voltage at device power contact 112. Specifically, control voltage circuit 230 may ignore a zero reading from area integrator 910 when a voltage at device power contact 112 is negative. Put another way, control voltage circuit 230 may ignore readings of zero from area integrator 910 when the voltage of battery 210 and the voltage on device contact 112 have a different polarity. The voltage at device contact 112, waveform 320, may become positive at time 329 until time T2. The areas under the curve of waveform 320 during these times may be represented as A3 and A4. At time T2, the areas A1, A2, A3, and A4 may add up to approximately zero. At time T2, area integrator 910 may drive an output of control voltage circuit 230, shown here as waveform 310, low at edge 314 such that switch 220 is closed. At time T2, area integrator 910 may be optionally reset to avoid any drift.

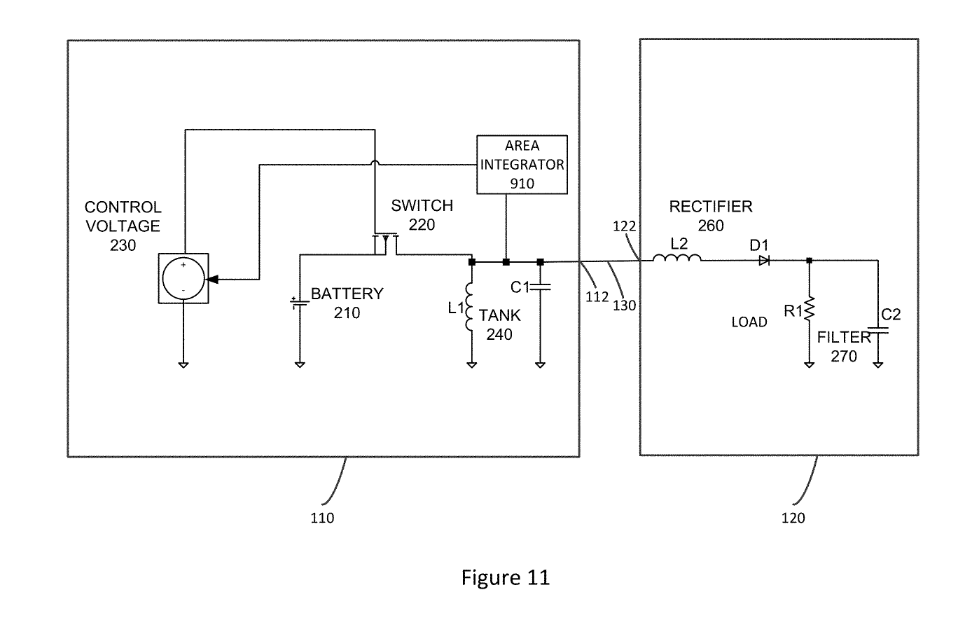

FIG. 11 illustrates a simplified schematic of the power transfer system of FIG. 9. In this example, area integrator 910 may be connected to device power contact 112. Area integrator 910 may take an average value of the waveform at device power contact 112 and provide an output to control voltage circuit 230. When the output of the area integrator is at or near zero and the voltage on the device power contact is positive, control voltage circuit 230 may close switch 220, thereby connecting battery 210 to device power contact 112. At this time, area integrator 910 may be optionally reset.

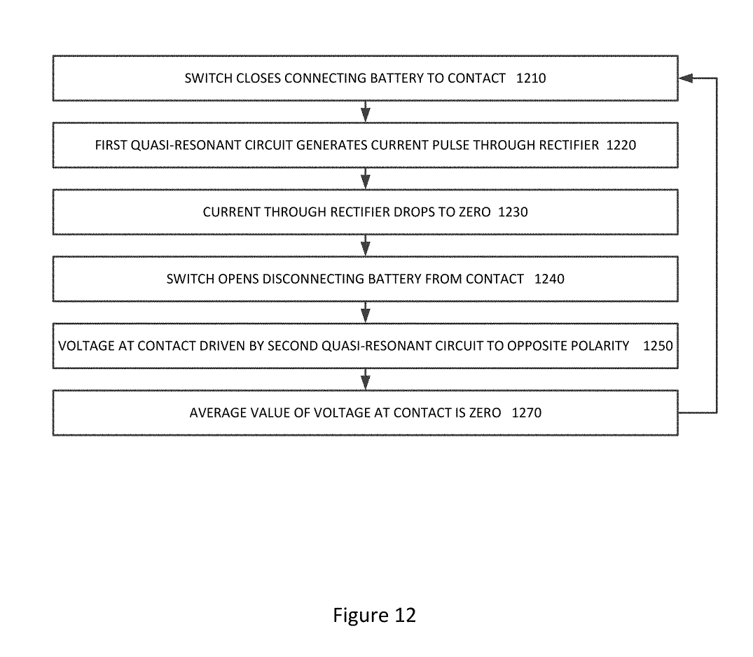

FIG. 12 is a flowchart of the operation of the power transfer system of FIG. 9. In act 1210, a switch may close connecting a battery to a contact. In act 1220, a first quasi-resonant circuit may provide current through a rectifier. In act 1230, current through the rectifier may drop to at least approximately zero. The switch may then open, thereby disconnecting the battery from the contact in act 1240. A second quasi-resonant circuit may drive the voltage at the contact to an opposite polarity in act 1250. In act 1260, an area integrator may determine that the average value of the voltage on the contact has returned to zero (and the voltage is the same polarity as the battery voltage.) The switch may again close in act 1210, thereby starting a new cycle.

In these embodiments of the present invention, when switch 220 connects battery 210 to device power contact 112, a current pulse may be provided through rectifier 260 to filter 270. When the current pulse into the filter reaches zero, power delivery ceases. When this occurs, it may be desirable for the first period to end, that is, for battery 210 to be disconnected from device power contact 112. Accordingly, when the current into rectifier 260 drops to zero or near zero, it may be desirable for switch 220 to open, thereby disconnecting battery 210 from device power contact 112. Accordingly, embodiments of the present invention may employ a current sense circuit coupled between battery 210 and device power contact 112. When the current sense circuit detects that current flow has ceased, it may provide an output to control voltage circuit 230 to open switch 220. An example of such a power transfer system is shown in the following figure.

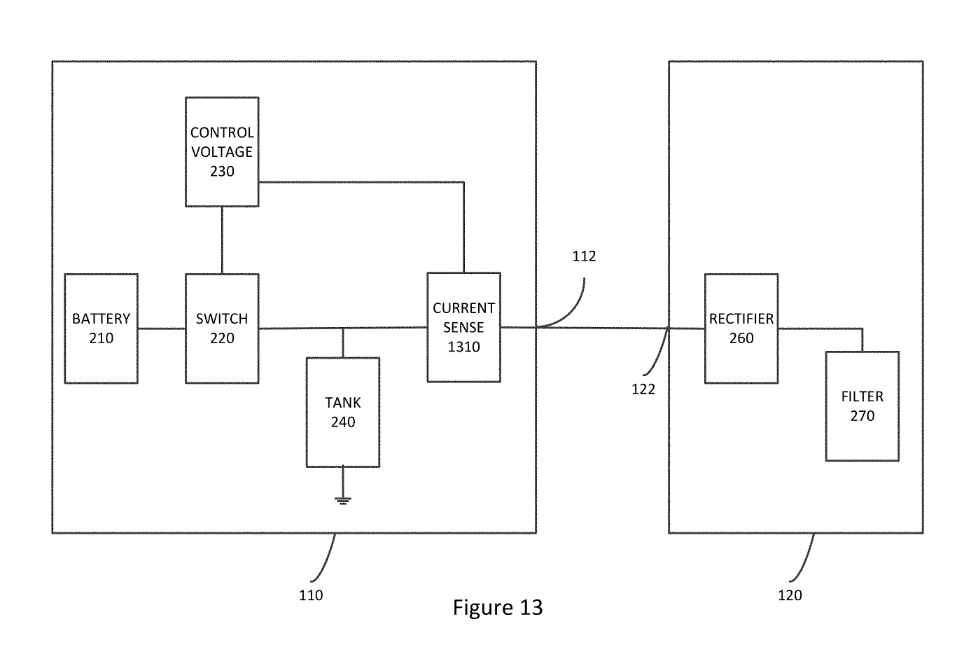

FIG. 13 illustrates a block diagram of a power transfer system that includes a current sense circuit according to an embodiment of the present invention. In this example, current sense circuit 1310 may be coupled between switch 220 and device power contact 112. In these and other embodiments of the present invention, current sense circuit 1310 may be coupled between battery 210 and switch 220. In still other embodiments of the present invention, current sense circuit 1310 may be located in accessory 120. When current sense circuit 1310 determines that current is not flowing, or flowing at a minimum rate, from battery 210 into rectifier 260, current sense circuit 1310 may provide a signal to control voltage circuit 230. Control voltage circuit 230 may open switch 220, thereby disconnecting battery 210 from device power contact 112. Current sense circuit 1310 may be combined in power transfer circuits with either area detector 910 or comparator 650 in various embodiments of the present invention.

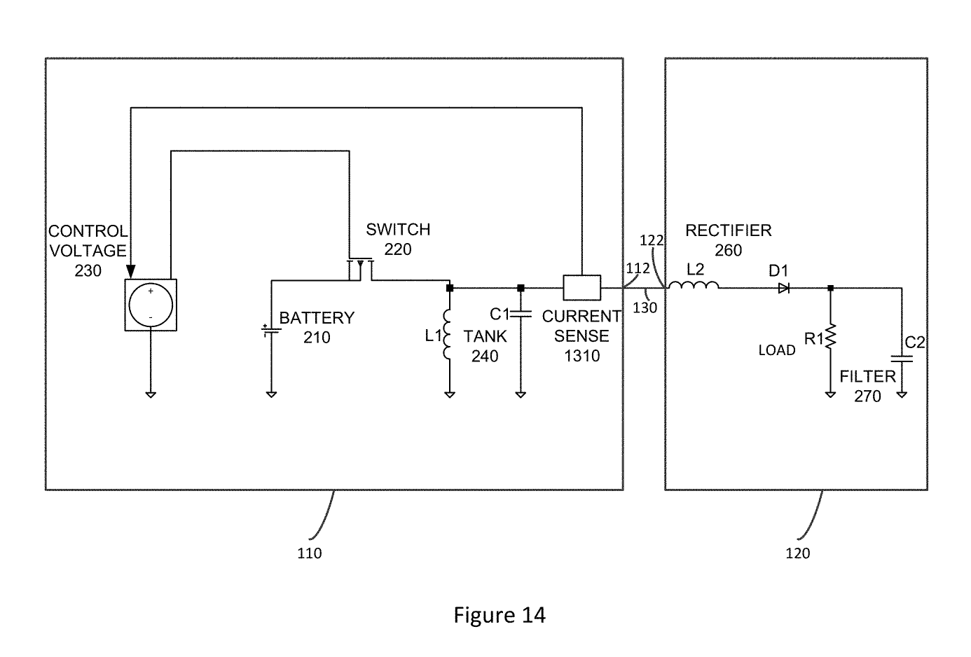

FIG. 14 illustrates a simplified schematic of the power transfer system of FIG. 13. As before, current sense circuit 1310 may be coupled between switch 220 and device power contact 112, though in these and other embodiments of the present invention, current sense circuit 1310 may be coupled between battery 210 and switch 220. In these and other embodiments of the present invention, current sense circuit 1310 may be located in accessory 120. Current sense circuit 1310 may be a low-value resistor or other circuit. When the voltage across the series resistor falls to near zero volts, current sense circuit 1310 may determine that current is not flowing, or flowing at a minimum rate, from battery 210 into rectifier 260. Current sense circuit 1310 may then provide a signal to control voltage circuit 230. An output of control voltage circuit 230 may return high, turning off switch 220 and thereby disconnecting battery 210 from device power contact 112. Current sense circuit 1310 may be combined in power transfer circuits with either area detector 910 or comparator 650 in various embodiments of the present invention.

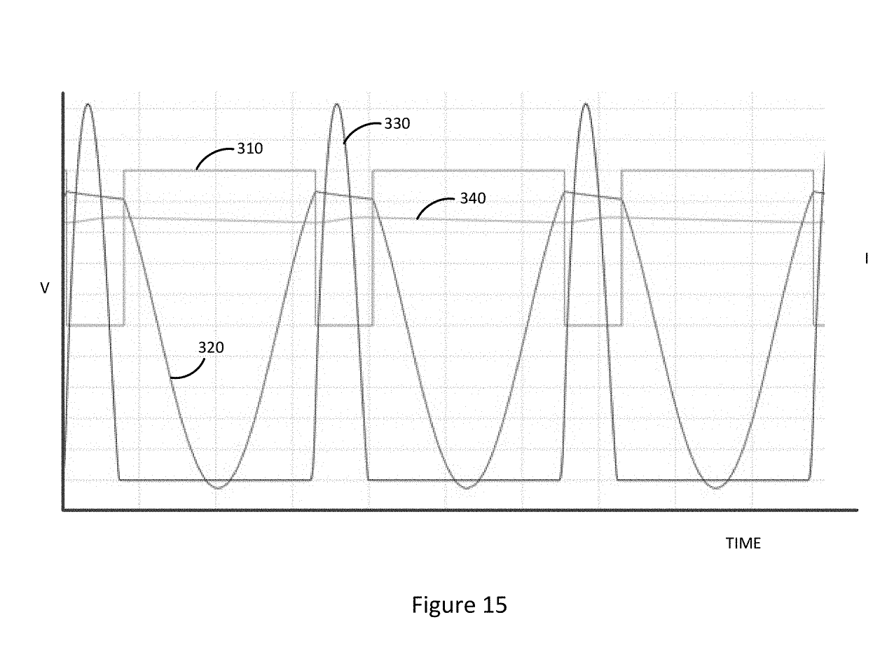

FIG. 15 is a timing diagram for a voltage delivery system according to an embodiment of the present invention. In this example, several cycles are shown. Specifically, an output of control voltage circuit 230 is shown as waveform 310, a voltage at device power contact 112 is shown as waveform 320, a current into diode D1 in rectifier 260 is shown as waveform 330, and a voltage at filter 270 is shown as waveform 340. The waveform 340 may be a power supply voltage that is provided to circuitry in or associated with accessory 120.

In these and other embodiments of the present invention, an alternating voltage having a zero average value may be provided on device power contact 112 of host device 110. This may reduce corrosion on device power contact 112 while allowing device power contact 112 to be used in delivering power to accessory 120. Corrosion may similarly be reduced on contacts of connector inserts at each end of a cable 130 (if used), as well as on accessory power contact 122 of accessory 120.

In these and other embodiments of the present invention, battery 210 may provide a positive voltage and when the second quasi-resonant or tank circuit 240 rings, it may ring below ground. In these and other embodiments of the present invention, battery 210 may provide a negative voltage and when the quasi-resonant or tank circuit 240 rings, it may ring above ground.

In these and other embodiments of the present invention, host device 110 may provide power to accessory 120 and host device 110 may include battery 210, switch 220, and the second quasi-resonant circuit, while accessory 120 may include rectifier 260, filter 270, and the first quasi-resonant circuit. In these and other embodiments of the present invention, accessory 120 may provide power to host device 110 and accessory 120 may include battery 210, switch 220, and the second quasi-resonant circuit, while host device 110 may include rectifier 260, filter 270, and the first quasi-resonant circuit. In these and other embodiments of the present invention, each device may be capable of providing power to the other and may each include these or other circuits.

Embodiments of the present invention may provide power delivery circuits and apparatus that may be located in various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, adapters, remote control devices, chargers, and other devices.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. An electronic system comprising:
a host device comprising:
a device power contact;
a power supply to provide a power supply voltage having a first polarity;
a switch to couple the power supply to the device power contact for a first period and then to disconnect the power supply from the device power contact for a second period, the second period following the first period;
a quasi-resonant circuit to cause a voltage on the device power contact to ring during the second period such that the voltage on the device power contact has a second polarity during a portion of the second period, the second polarity opposite the first polarity.

2. The electronic system of claim 1 wherein the voltage on the device power contact at the end of the second period is approximately equal to the power supply voltage.

3. The electronic device of claim 1 wherein the switch comprises a transistor.

4. The electronic device of claim 3 wherein the power supply comprises a battery.

5. The electronic device of claim 4 wherein the quasi-resonant circuit comprises a parallel combination of an inductor and a capacitor.

6. The electronic device of claim 5 further comprising a comparator to detect that the voltage on the device power contact is approximately equal to the power supply voltage and to then to close the switch to couple the power supply to the device power contact.

7. The electronic device of claim 6 wherein the comparator has a first input coupled to the device power contact, a second input coupled to the power supply, and an output coupled to the switch.

8. The electronic system of claim 1 wherein the first period and the second period comprise a cycle, and wherein the average voltage on the device power contact for a cycle is at least approximately zero volts.

9. The electronic system of claim 8 further comprising an area detector having an input coupled to the device power contact and an output coupled to the switch.

10. The electronic system of claim 2 further comprising an current sense circuit coupled in series between the switch and the device power contact, and further coupled to the switch.

11. The electronic system of claim 2 further comprising:
an accessory comprising:
an accessory power contact coupled to the device power contact;
a rectifier having an input coupled to the accessory power contact; and
a filter coupled to an output of the rectifier.

12. The electronic system of claim 11 wherein the rectifier comprises a half-wave rectifier.

13. The electronic system of claim 12 wherein the rectifier comprises a diode.

14. The electronic system of claim 12 further comprising an inductor in series with the rectifier, the rectifier comprising a diode, the inductor having a first terminal coupled to an anode of the diode.

15. The electronic system of claim 11 wherein the filter comprises a capacitor.

16. An electronic system comprising:
a host device comprising:
a battery;
a device power contact;
a switch coupled between the battery and the device power contact; and
a quasi-resonant circuit coupled to the device power contact.

17. The electronic system of claim 16 wherein the host device provides a voltage at the device power contact that has an average value that is at least approximately equal to ground.

18. The electronic system of claim 16 wherein the host device provides a voltage at the device power contact that has an average value that is at least approximately zero volts.

19. The electronic system of claim 16 further comprising:
an accessory comprising:
an accessory power contact to couple to the device power contact;
a rectifier having an input coupled to the accessory power contact; and
a capacitor coupled to an output of the rectifier.

20. An electronic system comprising a host device to transfer power to an accessory via a device power contact, where a voltage at the device power contact is approximately equal to a battery voltage for a first period and then rings in an approximately sinusoidal waveform for a second period, such that at an end of the second period the voltage at the device power contact is approximately equal to the battery voltage,
wherein the battery voltage has a first polarity and the voltage at the device power contact has a second polarity for a portion of the second period, the second polarity opposite the first polarity.
